(19) United States
(12) Patent Application Publication
(10) Pub. No.: US 2022/0048543 A9
(43) Pub. Date: Feb. 17, 2022

(54) Transit cleaning unit

(71) Applicant: Richard William Lewis, II, Stone Mountain, GA (US)

(72) Inventor: Richard William Lewis, II, Stone Mountain, GA (US)

(21) Appl. No.: 15/932,753

(22) Filed: Apr. 19, 2018

Related U.S. Application Data
(60) Provisional application No. 62/603,504, filed on Jun. 5, 2017.

(51) Int. Cl. B61D 35/00; B08B 9/049; B61B 13/10; B61C 3/00

(52) U.S. Cl. CPC B61D 35/00; B61C 3/00; B61B 13/10; B08B 9/0492

(57) ABSTRACT

Transit Cleaning Unit is able to clean the walls, overhead, insulators third rail covers and flooring of the subway systems in a minimum amount of time.

It provides an effective means of providing a clean environment for the benefit of the customers.

### BACKGROUND OF THE INVENTION

There is a considerable accumulation of dirt that is on the overheads, walls, decking and insulators in the rail transit systems.

### BRIEF SUMMARY OF THE INVENTION

As the need for public transit increases around the world, the requirement to provide a clean environment for the customer is a high priority.

The dirt that accumulates on the tunnel walls, overheads, and decking is presenting a unsafe and unhealthy environment for the clientele using the rail service daily.

TCU provides a means of cleaning the rail transit system maintaining a safe attractive tunnel and station environment.

### BRIEF DESCRIPTION OF THE SEVERAL VIEWS OF THE DRAWINGS

The several views of the drawings provide the positions of the different components and their function.

### BRIEF DESCRIPTION OF THE DRAWINGS

Although the characteristic feature of this invention will particularly be pointed out in the claims; the invention itself and manner in which it may be made and used may be better understood after review of the following description, taken in connection with the accompanying drawings wherein like numeral annotations are provided throughout.

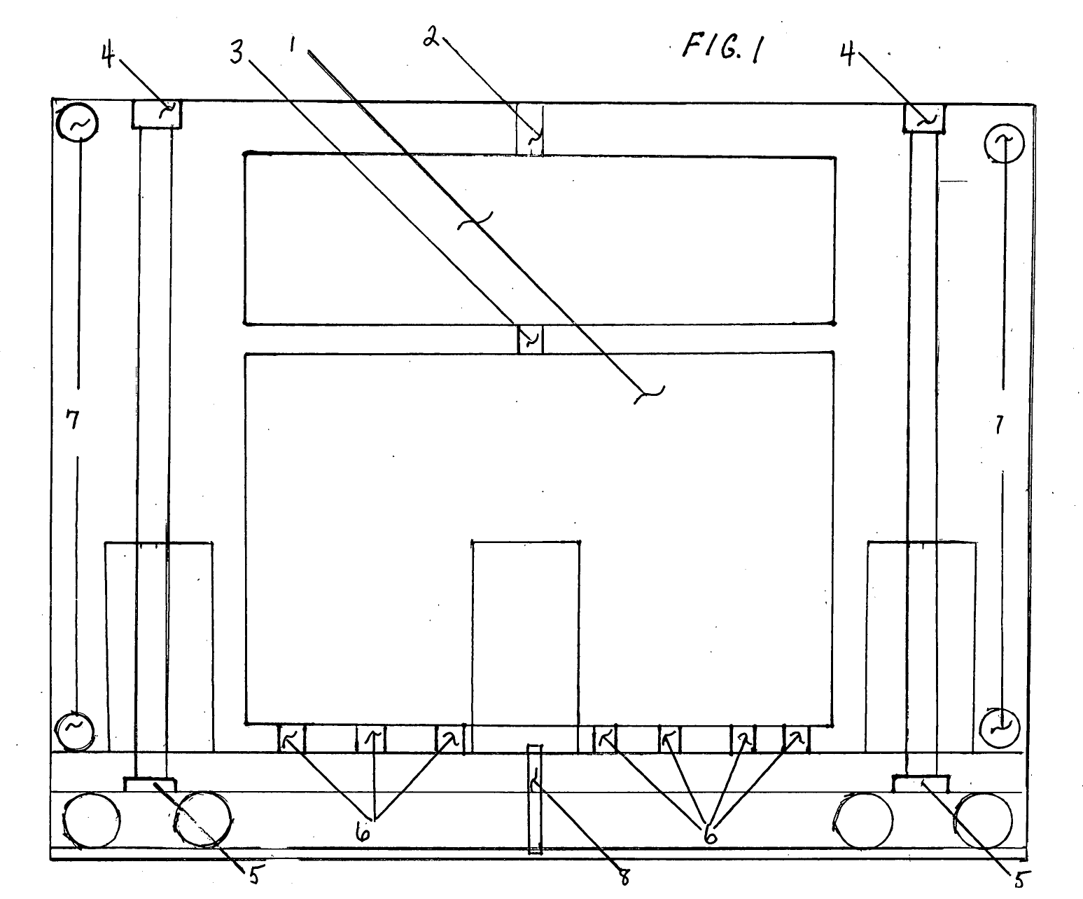

FIG. 1

Side view of location of general layout of components of work car

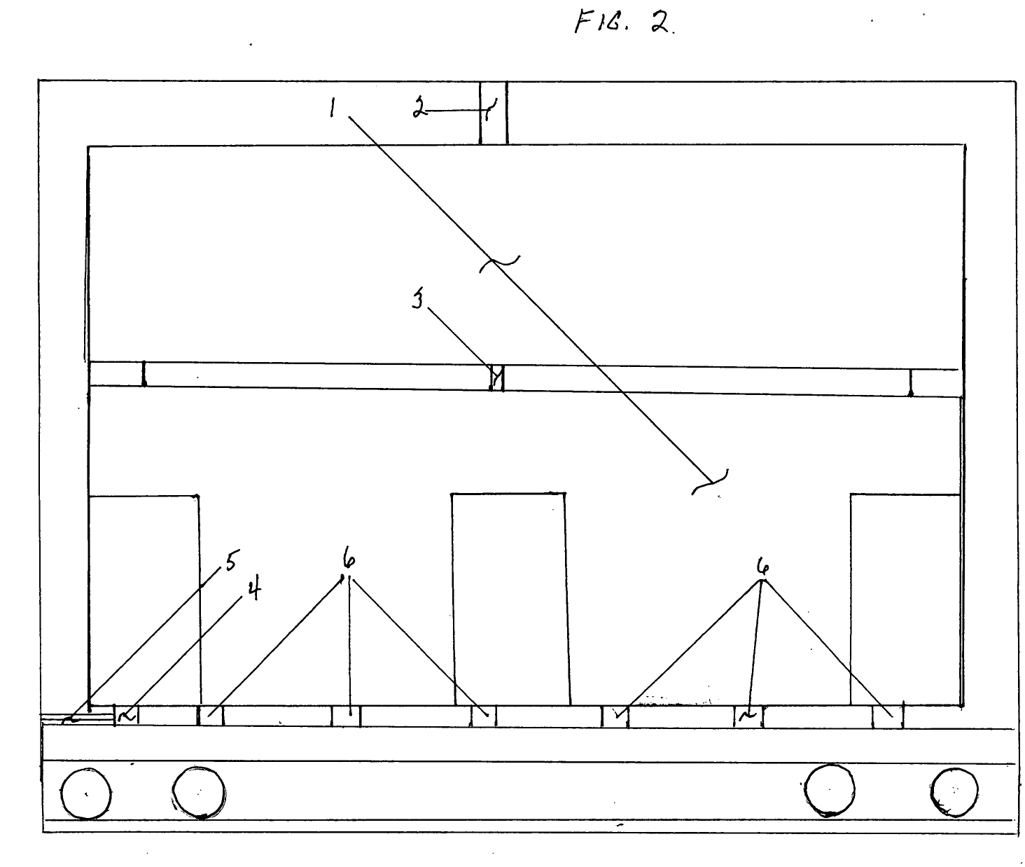

FIG. 2

Side view of location of general layout of components of supply car

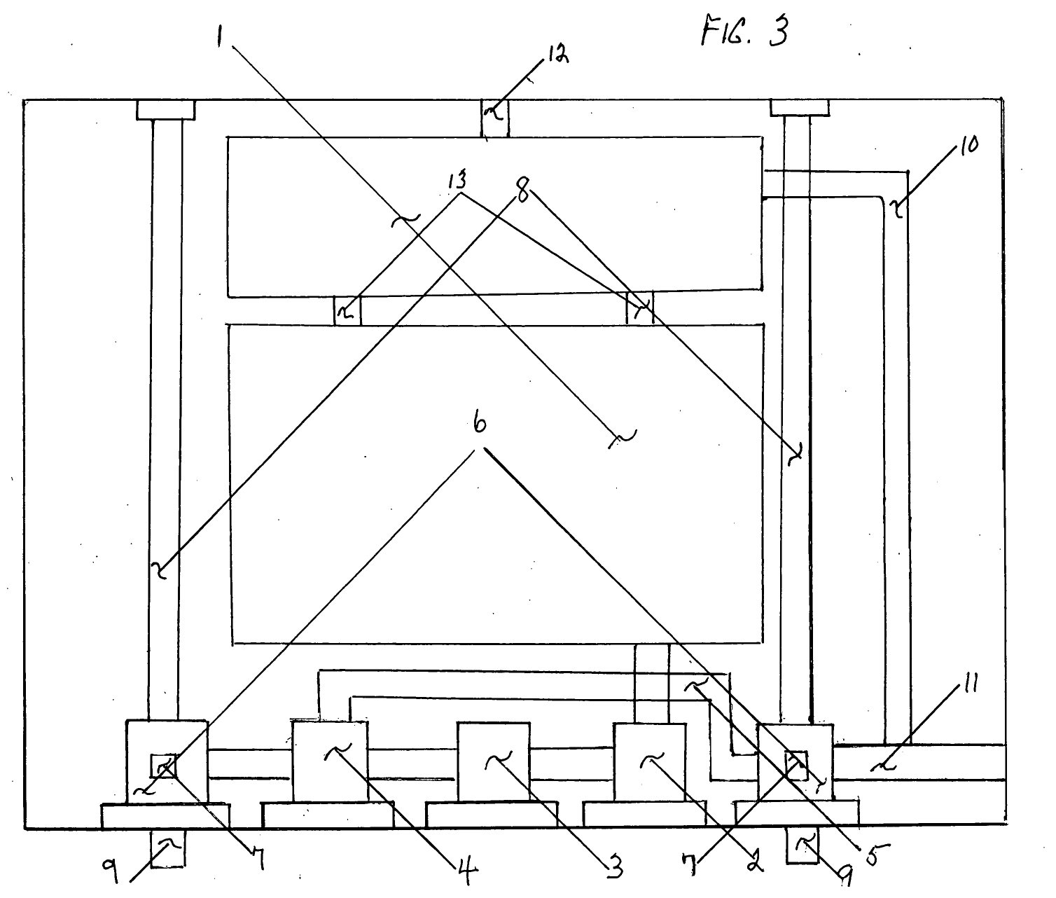

FIG. 3

Detailed side view of location of various components that make up the work cars.

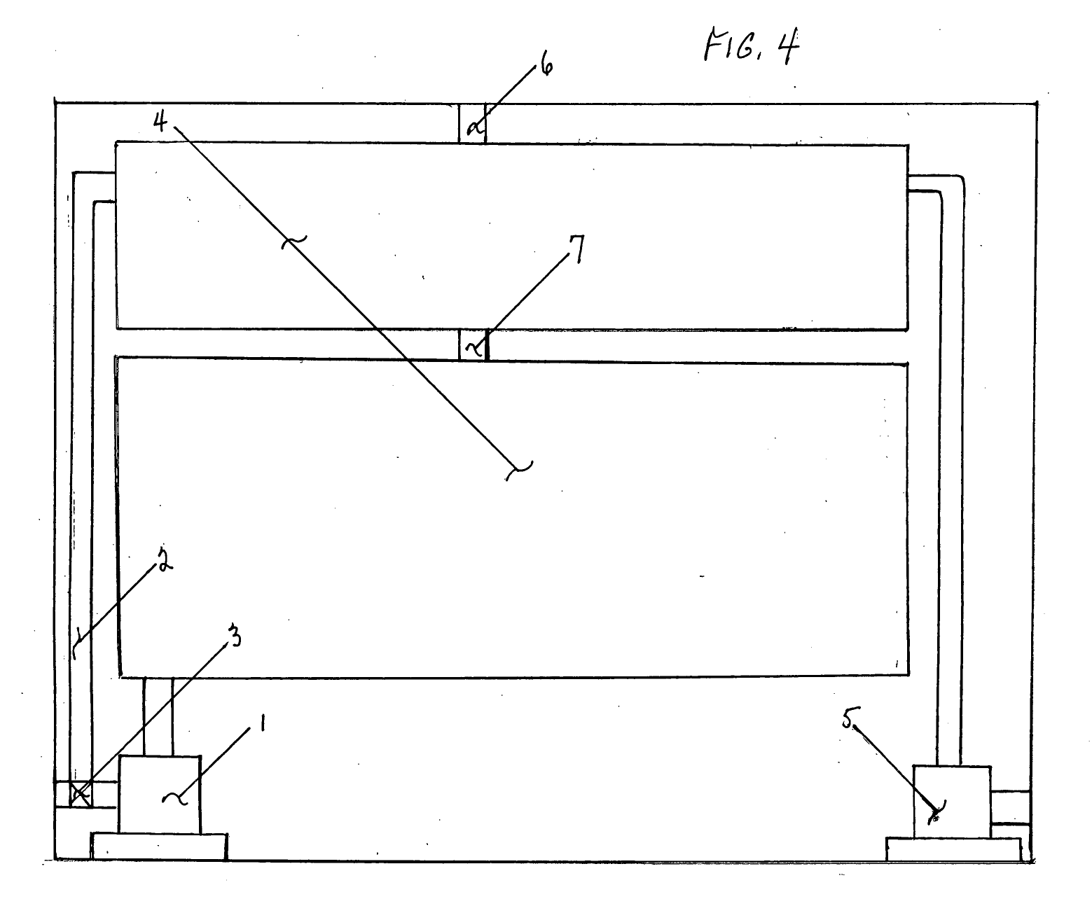

FIG. 4

Detailed side view of location of various components that make up the supply cars.

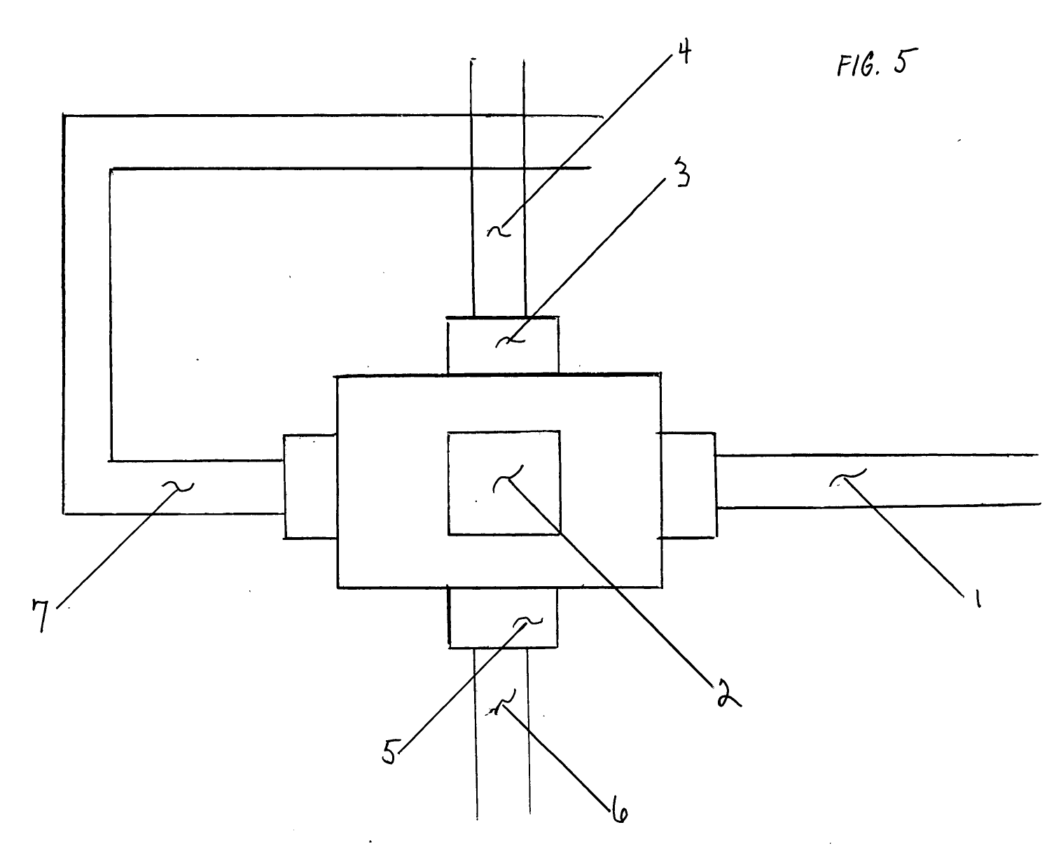

FIG. 5

Side view of 6 way solenoid selector valve

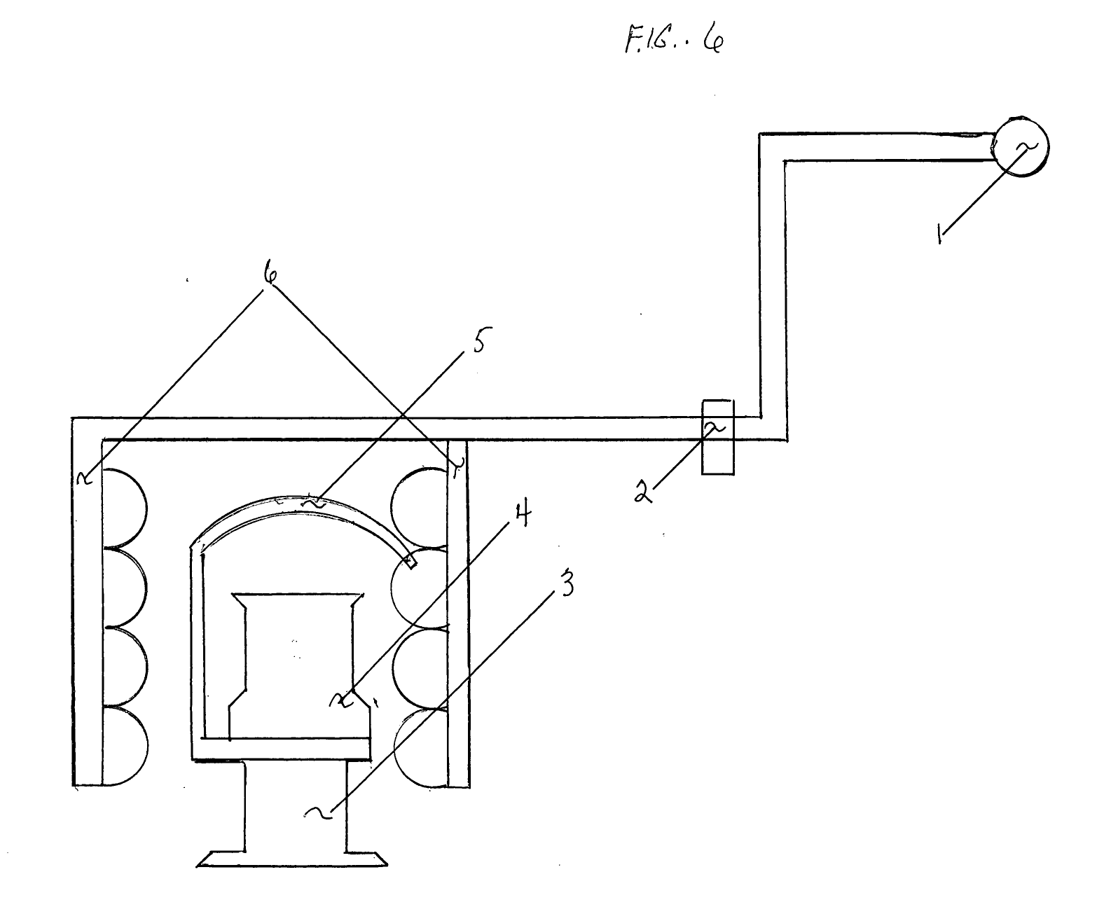

FIG. 6

Forward/Aft view of insulator third rail cleaner

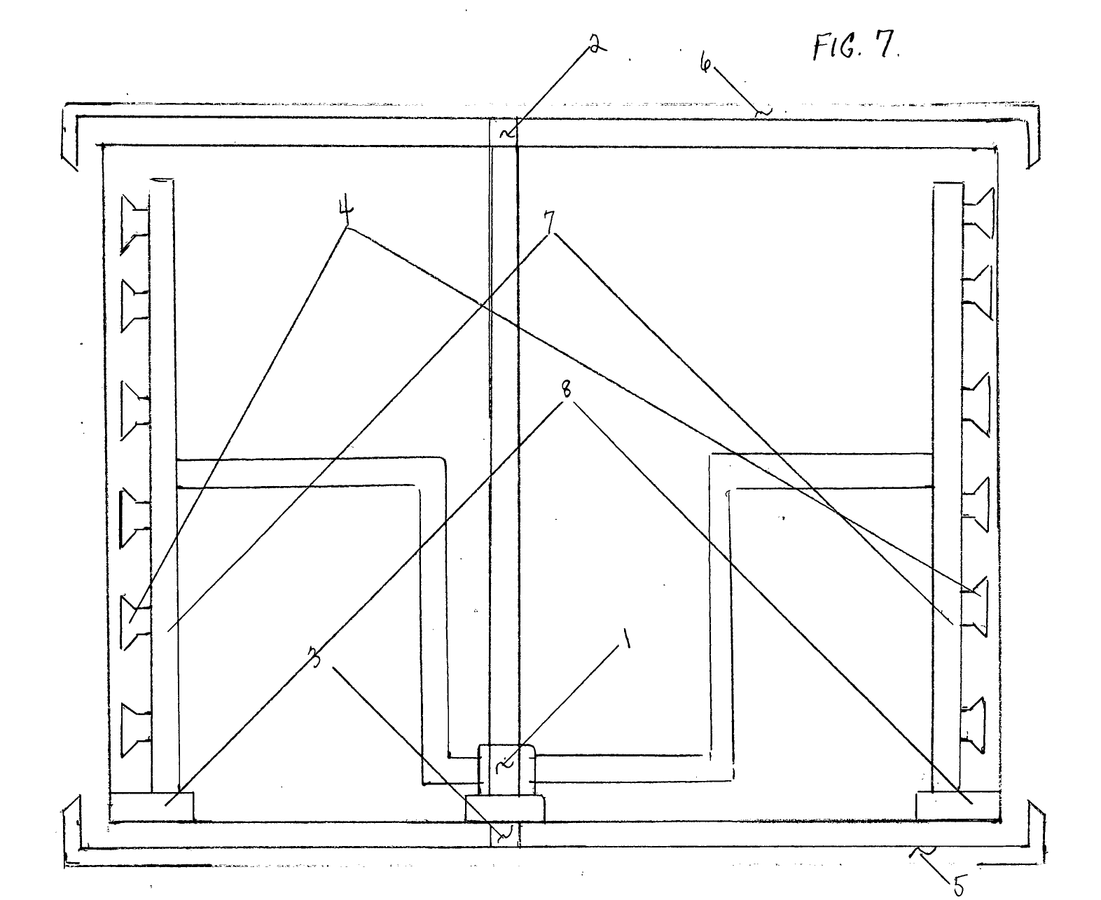

FIG. 7

Side view of 6 way solenoid selector valve and wall nozzles

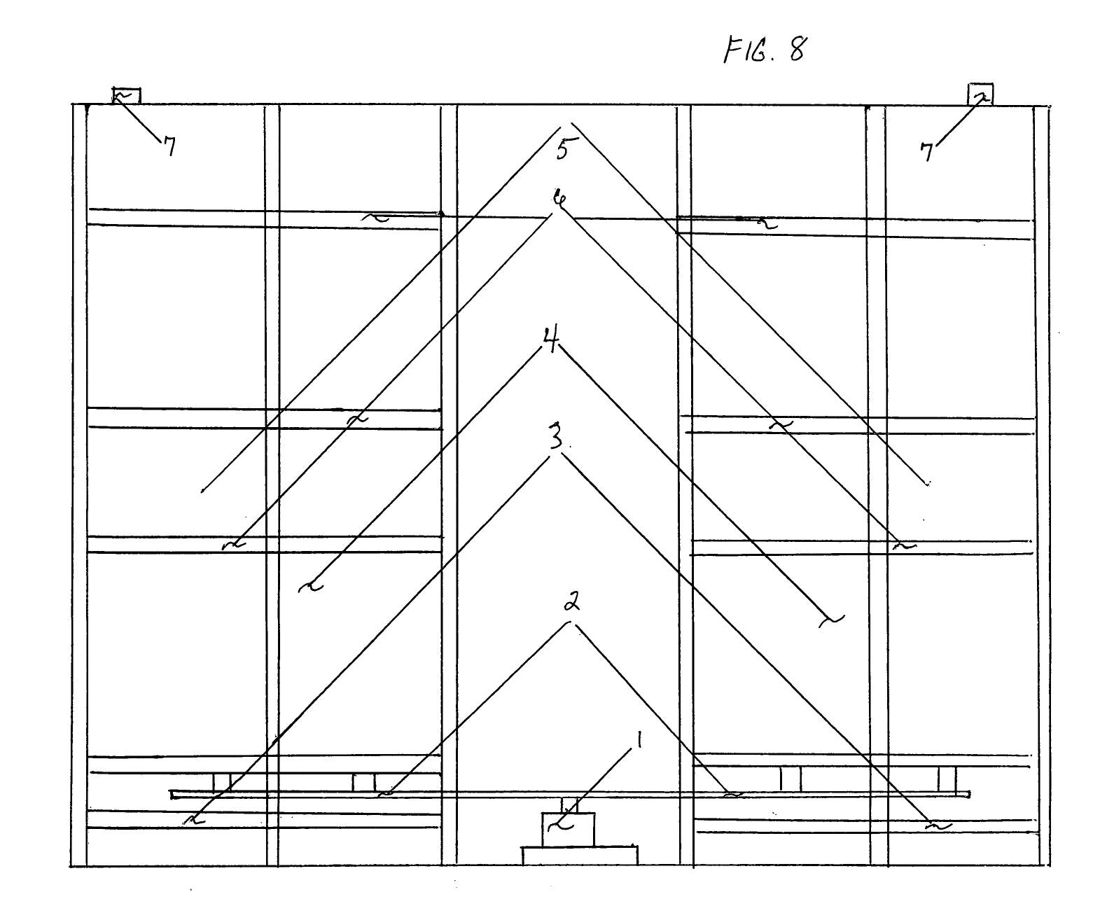

FIG. 8

Forward/aft view of water tank securing brackets

### DETAILED DESCRIPTION OF THE INVENTION

Transit Cleaning Unit is a transit rail car that been modified by the removal of the passenger seating and replaced by the positioning of the water tanks, secured to the car by brackets and decking supports.

The water tanks supply water to the variable displacement pumps that sends a flow to the on demand hot water heater that sends flow to the 5,000 P.S.I. pressure washer that sends pressurized hot water to the 6 way forward and aft solenoid activated selector valves that direct the pressurized water to the overhead, decking, wall, and insulator nozzles.

As the operation is underway, the 6 way forward and aft solenoid activated selector valves receive the signal from the PLC to direct the flow to the correct nozzles or back to either the work car tanks or the supply car tanks.

As TCU moves into place on the designated work area the PLC receives the signal from the laser light priority lights to extend the third rail/insulator cleaner. As the work car enters the customer station, the PLC is sent a signal to retract the third rail/insulator cleaner. When the work car exits the station the third rail/insulator cleaner is extended.

In order to give TCU the maximum amount of serviceable time, a variable displacement pump is installed on the aft portion of the supply cars permitting more supply of water.

The Programmable Logic Control (PLC) located in the operators' station receives signals from the laser light priority switches located forward and aft of the work car to activate the different nozzles at the correct time.

A supply car is positioned aft of the work car for the purpose of supplying the required water to conduct extended operations.

Transit Cleaning Unit consists of 2 work cars and 2 supply cars.

This is to permit the best operations by permitting the unit to have the maximum resources to clean as much area in the least amount of time.

When the unit reaches the end of a certain designated line, the operator can simply board the work car on the other end and continue operations on another line.

### DETAILED DESCRIPTION OF THE DRAWINGS

Note:

Components in the drawings are exploded in order to verify their placement in the overall ability of the total system to operate properly.

Several drawings describe the placement of the components order to permit the proper operation of TCU. The specific mechanics of how they are secured to the TCU and the different connections required will be between the inventor and the manufacturer.

FIG. 1

General Side View of the Location of Components that Makeup the Work Car
1) Primary supply tanks
2) Fill ports
3) Transfer ports
4) Overhead nozzles
5) Decking nozzles
6) Tank supports
7) Laser light priority switch
8) Hydraulic system/third rail cover/insulator cleaner

FIG. 2

General Side View of the Location of Components that Makeup the Supply Car.
1) Secondary supply tanks
2) Fill ports
3) Transfer ports
4) Secondary variable pump
5) Secondary fill line
6) Tank supports

FIG. 3

Detailed Side View of the Location of Components that Makeup the Work Car
1) Main supply tanks
2) Main variable displacement pump—create flow to all system components
3) On demand hot water heater—creates hot water to flow to 5,000 P.S.I pressure washer
4) 5,000 P.S.I. pressure washer provides pressurized water to overhead, wall, decking and insulator nozzles
5) Piping directing pressurized water to aft 6 way solenoid energized selector valve
6) 6 way solenoid energized selector valve (forward and aft)—directs flow of water on demand from P.L.C. to various nozzles and return to supply tank when nozzles are inactive.
7) Port to forward/aft wall nozzles
8) Piping to overhead nozzles
9) Piping to decking nozzles
10) Return piping to supply tanks
11) Supply line from supply car
12) Fill port
13) Transfer ports

FIG. 4

### Detailed Side View of Supply Car

1) Secondary variable displacement pump
2) Return line to secondary tanks
3) Flow check valves
4) Secondary supply tanks
5) Secondary pump
6) Fill port
7) Transfer ports

FIG. 5

### Side View of 6 Way Solenoid Energized Selector Valve

1) Main supply port
2) Port to wall nozzles
3) Overhead nozzle fitting
4) Overhead nozzle supply piping
5) Decking nozzle fitting
6) Decking nozzle piping
7) Return piping to main water tanks when nozzles are in active

FIG. 6

### Forward/Aft View of Insulator, Third Rail Cover Cleaner

1) Supply valve from 5,000 P.S.I. pressure washer
2) Hydraulic motor
3) Insulator
4) Third rail
5) Third rail cover
6) Manifold housing for insulator, third rail cover cleaner pressure nozzles

FIG. 7

### Forward/Aft View of 6 Way Solenoid Directional Valve Overhead, Decking and Wall Nozzles

1) Six way directional valve
2) Overhead nozzle piping
3) Decking nozzle piping
4) Wall nozzle ports
5) Decking nozzle manifold
6) Overhead nozzle manifold
7) Wall nozzle manifold
8) Wall nozzle support bracket

FIG. 8

### Water Tank Securing Brackets

1) Secondary Variable pump
2) Supply piping
3) Tank supports
4) Inboard secondary tank
5) Outboard secondary tank
6) Tank brackets
7) Fill ports

I claim:

1-20. (canceled)

21. The Transit Cleaning Unit uses 5,000 P.S.I. hot water pressure to remove the harmful dirt that gathers in the tunnels of the rail transit system.

22. Transit Cleaning Unit is powered by existing third rail power.
